(19) United States
(12) Patent Application Publication
(10) Pub. No.: US 2010/0304669 A1
(43) Pub. Date: Dec. 2, 2010

(54) SATELLITE AND WIMAX COMMUNICATION SYSTEM AND METHOD

(75) Inventors: Doron Ezri, Petah Tikva (IL); Michael Erlihson, Petah Tikva (IL)

Correspondence Address: SMITH FROHWEIN TEMPEL GREENLEE BLAHA, LLC, Two Ravinia Drive, Suite 700, ATLANTA, GA, 30346, US

(73) Assignee: RUNCOM TECHNOLOGIES LTD., Petah Tikva (IL)

(21) Appl. No.: 12/526,947

(22) PCT Filed: Feb. 18, 2008
(86) PCT No.: PCT/IL2008/000207

§ 371 Date: Jan. 11, 2010

(30) Foreign Application Priority Data
Feb. 18, 2007 (IL) 181399

(51) Int. Cl. H04B 7/185

(52) U.S. Cl. 455/13.1

(57) ABSTRACT

A method for maintaining satellite diversity for a WiMAX system comprising: A. Dividing a set of UTs or users into subsets wherein each set is devised such that the maximal time delay between its members does not exceed the GI length; B. One or more BS's or satellites acquires information or estimation regarding relative delay between subsets; C. A different FFT is performed for each subset, wherein each has its own time alignment; D. Interference reduction means are implemented in the frequency domain between subsets.

The present application claims priority from the patent application No. 181399 filed in Israel on 18 Feb. 2007 by the same applicant and having the same title.

This invention relates to WiMAX communication system and method and more specifically to handling satellite diversity in WiMAX.

Some 802.16e and/or WiMAX communication systems, such as S-WiMAX systems, may include communicating with one or more satellites. Although downlink DL communication from a satellite to Mobile Subscribers MS or user terminals UTs spread in a wide area may be implemented with one satellite, it may be impractical to receive uplink UL transmission from all the users by one satellite.

When there is one satellite, ranging and setting appropriate time delays for each of the user terminals can reduce synchronization problems, however when two or more satellites are in use, with some distance between them, there is a satellite diversity. This becomes a problem—as user terminals might interfere each other while some are transmitting to the other satellite.

Thus, in transmission schemes for S-WiMAX in satellite diversity in the UL the users should preferably be synchronized, in the time domain, to one satellite, however this temporal alignment no longer holds when the UL signals arrive at the second satellite.

The problem becomes challenging due to the large relative delay between users arising from the large geographical variance. In the case where the relative delay exceeds a guard-interval GI of the OFDM symbols, which may be approximately 50 microseconds, inter-symbols interference ISI would be present and special care should be taken to minimize the interference.

### SUMMARY OF THE INVENTION

Current invention details a novel solution for handling UL transmissions to WiMAX satellites.

UTs are divided into subsets. Each subset is defined in a manner that would limit the maximal time delay between its members, for their unified UL transmission to a certain satellite.

Thus, the difference in time delay of one subset to a certain satellite does not exceed the GI length. This means that users that are members of a subset are actually close geographically.

The relative delay between subsets may exceed the GI length.

Two or more satellites may handle the UTs by the subsets division, thus satellite diversity is handled by allocating subsets to different time and/or frequency resources.

Thus, less interferences will occur and the weak UTs transmissions may be better received at the satellites.

Despite the S-WiMAX satellite diversity, the communication may be better synchronized, in the time domain, to each satellite.

The problem of big relative delay between users is reduced and may be completely solved, as subsets are defined in a manner to assure the time delay between UTs in one subset remains smaller than the GI of the OFDM symbols, and thus ISI is prevented or reduced as well.

This way, users in a certain subset do not cause ISI to each other, and reception may be conducted in the standard WiMAX fashion. The ISI problem is then between subsets, which can be partitioned to allow efficient UL.

### BRIEF DESCRIPTION OF THE DRAWINGS

FIG. 1 illustrates an S-WiMAX communication system with two Satellites and UTs divided to subsets

FIG. 2 details possible timing of OFDM symbols for S-WiMAX systems

FIG. 3 details a method for handling satellite diversity in S-WiMAX systems

FIG. 4 illustrates BER and PER simulation results with a different number of guard band subcarriers

### DETAILED DESCRIPTION OF THE PREFERRED EMBODIMENTS

The present invention will be described by way of example, and with reference to the accompanying drawings.

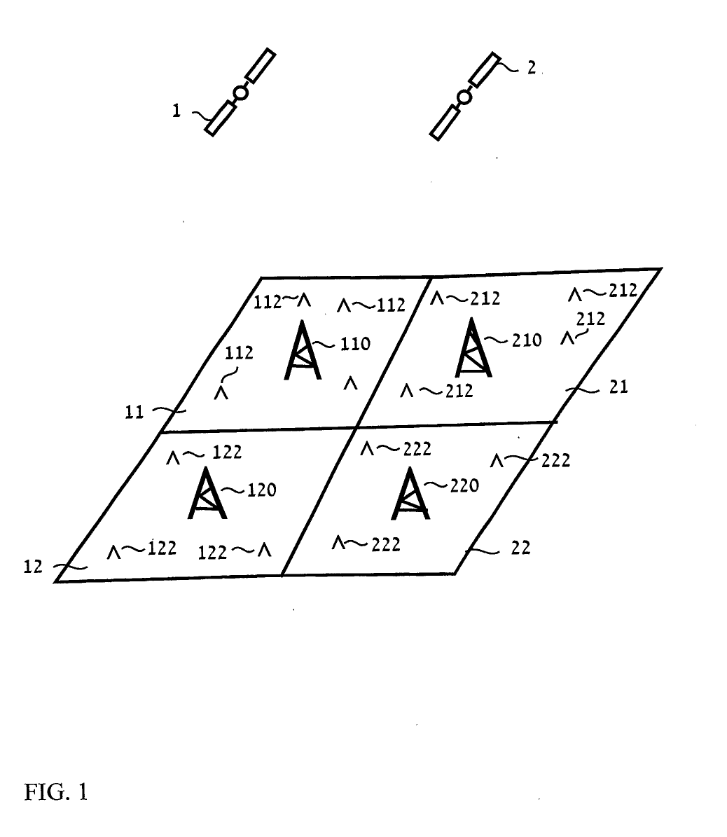

FIG. 1 illustrates an S-WiMAX communication system with two Satellites 1 and 2, UTs 112, 122, 212, 222 divided to subsets 11, 12, 21, 22 respectively. In each of the subsets 11, 12, 21, 22 there may be one or more base stations 110, 120, 210, 220 respectively.

Each satellite may communicate with relevant BS, UTs may communicate with terrestrial BS's and/or through any of the satellites.

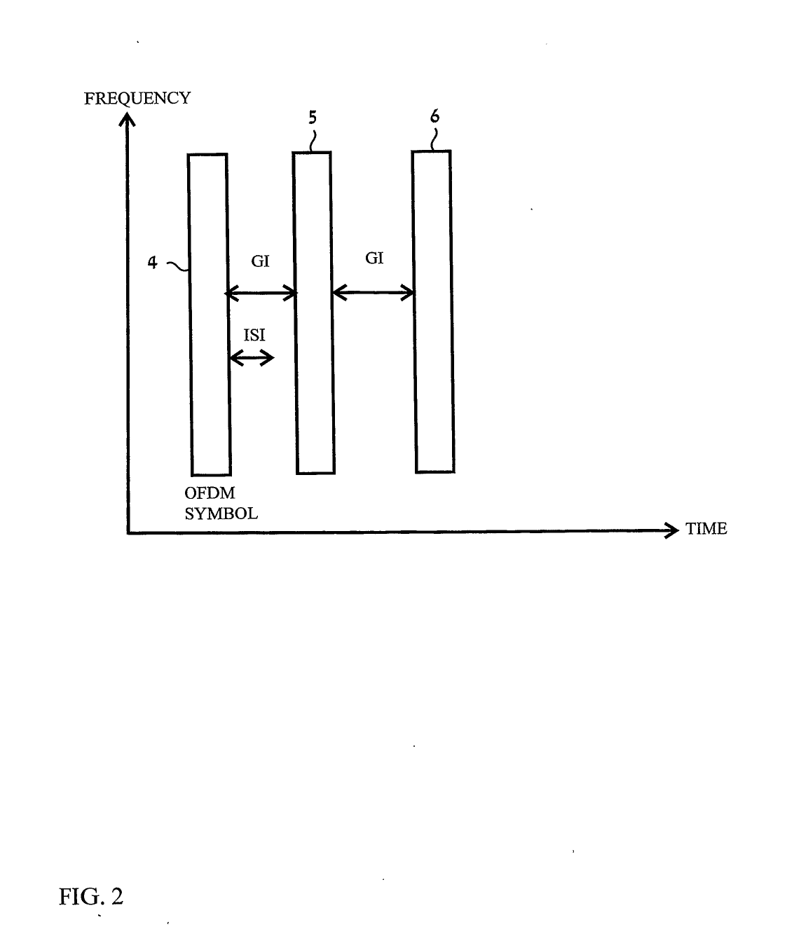

In a preferred embodiment, the subsets are allocated in a novel manner to allow time delay to one or more satellites, smaller than the GI, thus achieving an ISI smaller than Gi, as detailed in FIG. 2.

Thus, OFDM signals 4, 5 and 6 part of an OFDM UL, do not interfere each other as the ISI is attenuated in smaller time than GI. It may be simpler to perform FFT operations within a subset, reducing costs and UL to satellite complexity, while overall subsets management may be maintained by any one or more of the BS's.

The timing of OFDM symbols 4, 5 and 6 for the S-WiMAX system may allow the satellite trace each of the OFDM symbols of a certain subset within its GI.

Communication to a BS may be initiated either directly, or through a satellite, or combined. When there are UTs scattered over a wide area, some of them may be out of reach for a BS. They can thus connect to the BS through a satellite. Yet, UTs may know their subset belonging based on initial definition, notification from a satellite or BS, and/or by calculating its about location.

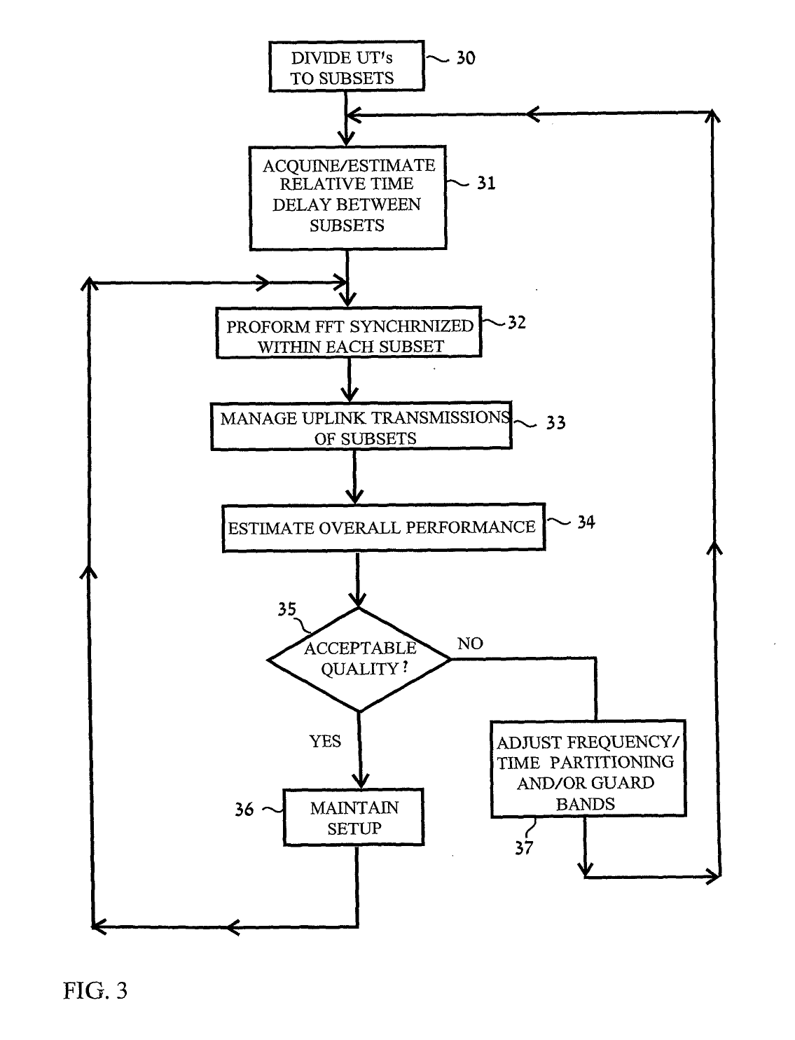

A preferred method for maintaining satellite diversity for a WiMAX system, such as detailed in FIG. 3, may include:

1. Divide a set of UTs or users into subsets 30. Each set is devised such that the maximal time delay between its members does not exceed the GI length.

Thus, the users that are members of the same subset are actually close geographically. This may be combined to match either one of the satellites or both. The relative delay between subsets may exceed the GI length.

This way, users in a certain subset do not cause inter-symbol interference to each other, and reception of one subset may be conducted in the standard WiMAX fashion. The problem of inter-symbol interference is then between subsets, but reduced at the subset level.

2. One or more BS's and/or satellites acquires information or estimation regarding relative delay between subsets 31, which is assumed as time invariant. This data may be used to later combine transmissions of subsets.

3. A different FFT operation can be performed for each subset 32, and the time alignment of the FFT can be based on the knowledge of the relative delay associated with the specific subset 33.

4. In order to decrease the interference in the frequency domain between subsets, which arises from the lack of orthogonality, it may be possible to adjust and/or define disjoint frequency bands 37 for each subset and partition them, such as by small number of sub carriers guard-bands.

This way, even though the signals belonging to different subsets are no longer orthogonal, the interference may be significantly reduced. It should be further noted that our assumption is that the system operates at the regime of low SNR, so that the interference should be kept small with respect to the link SNR.

Overall estimation 34 can be performed, to decide whereas to maintain current setup 36, or perform stage 37, which might be resource consuming. Accordingly, better performance can be achieved over time, adjusting frequency-time resources with subsets.

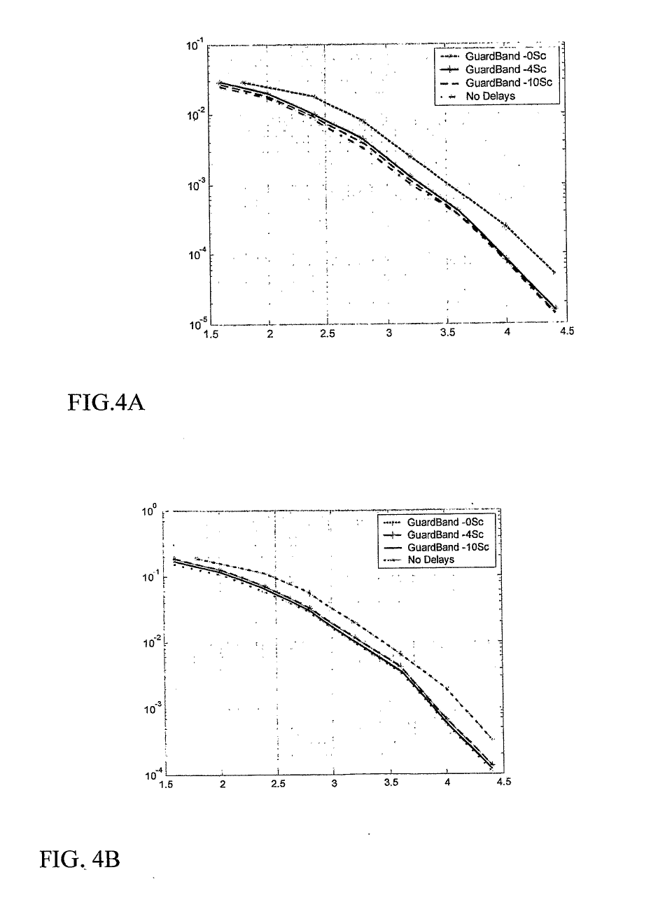

FIG. 4 illustrates BER and PER simulation results with a different number of guard band subcarriers. Simulation estimates for collaborative MIMO allocation may include FEC size of 72 bits, for example.

The results need not depend strongly on that allocation, and 4 subsets of users may be assumed wherein the maximal differential delay is smaller than the GI length. The inter subset maximal differential delay exceeds the GI length.

The BER and PER results in the simulation are effected by three cases of inter set guard band sizes: 0, 4 and 10 subcarriers. The figures show that in the case of no guard band, there exists a degradation of approximately 0.3 dB in BER with respect to the perfectly aligned case. The figures further show that in the case the guard band is larger than 4 subcarriers, the performance degradation in negligible.

Thus, it may be possible to initiate various test and measurement approaches 35, to define acceptable BER and/or PER, and set guard bands or use other means accordingly.

In a preferred embodiment, the 802.16e is used with GI≈⅛. The BS's are WiMAX compatible; the terrestrial BS's may include standard WiMAX equipment, while the BS that communicates through the satellite link is S-WiMAX adapted.

The S-WiMAX deployment may include the definition of subsets according to geographical considerations. The S-WiMAX and terrestrial BS, which are fixed geographically, may have this information. Any UT or equipment endowed with a GPS receiver, may be able to determine the location according to a pre-defined database. The terrestrial BS can inform the UT of the subset it is in.

The allocation can be done according to the spots of each satellite. That may be done according to the geographical position of the UT.

UT's users are assumed to be mobile. Thus HO from terrestrial BS to the S-WiMAX BS may be essential.

In one embodiment, the satellites may be geo-stationary so no movement with respect to the earth's surface might be sensed.

The actual area covered can be very big, thus it is divided into regions that correspond to subsets in a manner that the maximal differential delay between two users within a subset does not exceed the GI duration.

This invention enables using more than two satellites simultaneously as well with higher diversity.

In order to be able to reach the satellite, the UT may place all of its power on a small number of subcarriers, such as 4 SC's. The allocations are such that the SC's are consecutive in the frequency domain and remain fixed.

In another embodiment, which may be based on the simulation specification, the following may be used: BW=1.25 MHz, FFT size=512, GI=⅛. Each user may transmit over 4 consecutive subcarriers along the whole UL subframe (12 symbols). There are 4 subsets of users such that the maximal differential delay between users within a subset does not exceed the GI duration.

Each subset includes numerous users. Each subset is allotted a different band in the frequency domain (bands are disjoint). in contrast to WiMAX, the BS performs 4 (as the number of subsets) FFT operations, that differ in the starting point of the FFT (according to the average time delay of each subset).

The purpose of the simulation may be to verify the size of the guard band (between subsets allocation) necessary to avoid inter-set interference arising from inter-symbols interference due to lack of temporal synchronization between subsets.

In a preferred embodiment, the satellite link may form an FDD communication link. This means that the UL and DL are transmitted about different frequencies. In contrast, the WiMAX adopts the TDD concept, in which the UL and DL are transmitted about the same frequency in different time intervals. Thus, in S-WiMAX a half FDD scheme is suggested. In half FDD the UL and DL are transmitted about different frequencies and different time intervals.

It will be recognized that the foregoing is but one example of a system and method within the scope of the present invention, and that various modifications will occur to those skilled in the art upon reading the disclosure set forth hereinbefore.

1. A method for maintaining satellite diversity for a WiMAX system, the method comprising the steps of:
dividing a set of UTs or users into subsets wherein each set is devised such that the maximal time delay between its members does not exceed the GI length;
one or more BS's or satellites acquiring information or estimation regarding a relative delay between subsets;
performing a different FFT is for each subset, wherein each has its own time alignment; and
implementing interference reduction means in the frequency domain between subsets.

2. The method of claim 1, wherein overall estimation is performed to decide whereas to maintain current setup or repeat any one or more of the method steps.

3. (canceled)
